(19) United States
(12) Patent Application Publication
(10) Pub. No.: US 2008/0305379 A1
(43) Pub. Date: Dec. 11, 2008

(54) Polymer Electrolyte Membrane for Fuel Cell and Membrane-Electrode Assembly and Fuel Cell Including the Same

(75) Inventors: Bum Jin LEE, Uiwang-si (KR); Atsuo SOUNAI, Yokohamashi (JP)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CHEIL INDUSTRIES INC., Gumi-si (KR)

(21) Appl. No.: 12/191,689

(22) Filed: Aug. 14, 2008

Related U.S. Application Data
(63) Continuation-in-part of application No. PCT/KR2006/005902, filed on Dec. 29, 2006.

(30) Foreign Application Priority Data
Feb. 17, 2006 (KR) 10-2006-0015710
Nov. 6, 2006 (JP) 2006-300390

(51) Int. Cl. H01M 8/10

(52) U.S. Cl. 429/33

(57) ABSTRACT

Disclosed is a polymer electrolyte membrane for a fuel cell that has a high ionic conductivity even at a high temperature without humidification. The polymer electrolyte membrane comprises a film composed of a polyimide copolymer containing phenylbenzimidazole, and an acid impregnated within the polyimide copolymer film. Also disclosed is another polymer electrolyte membrane for a fuel cell that has good chemical resistance and improved physical properties when compared to those of the previous polymer electrolyte membrane.

### CROSS-REFERENCE TO RELATED APPLICATIONS

This non-provisional application is a continuation-in-part application of PCT Application No. PCT/KR2006/005902, filed Dec. 29, 2006, pending, which designates the U.S. and which is hereby incorporated by reference in its entirety, and claims priority therefrom under 35 USC Section 120. This application also claims priority under 35 USC Section 119 from Korean Patent Application No. 2007-0015710, filed Feb. 17, 2006, and Japanese Patent Application No. 2008-300390, filed Nov. 6, 2006, the entire disclosure of each of which is hereby incorporated by reference.

### FIELD OF THE INVENTION

The present invention relates to a polymer electrolyte membrane for a fuel cell, a membrane-electrode assembly using the electrolyte membrane, and a fuel cell comprising the assembly.

### BACKGROUND OF THE INVENTION

Polymer ion exchange membranes have been used extensively in various applications, such as diffusion dialysis, electrodialysis and vapor permeation separation. Recent attention has been directed toward developing polymer electrolyte fuel cells using cation-exchange polymers.

Fuel cells are energy conversion systems that effectively convert chemical energy stored in fuel into electrical energy. In fuel cells, hydrogen stored as a gas or methanol stored as a liquid or gas is combined with oxygen to produce electric power. Particularly, proton exchange membrane fuel cells (PEMFCs) are clean energy sources capable of replacing fossil fuels, and have high power density and high energy conversion efficiency.

Proton conductive polymer membranes known as electrolytes in fuel cells are commonly based on copolymers of perfluorosulfonic acid and tetrafluoroethylene. Fuel cells typically include the following elements: a polymer electrolyte membrane, electrodes, and a separator to form a stack, among other elements.

In general, a cathode and an anode are attached to a polymer electrolyte membrane by various methods to produce a membrane-electrode assembly. To maximize the surface area of a platinum catalyst, the two electrodes are made by adsorbing nanosized platinum particles on the surface of a carbon material (e.g., carbon black). The carbon material is typically in the form of a powder having an effective surface area of several hundred square meters per gram (m²/g), and the platinum particles act as catalysts for oxidation/reduction reactions.

The structure and performance of the membrane-electrode assembly are the most important factors in polymer electrolyte fuel cell technology. The generation of electricity from a fuel cell is based on the following principle. As depicted in Reaction 1, hydrogen as a fuel gas is supplied to an anode, adsorbed to a platinum catalyst of the anode and oxidized to generate protons and electrons.

2H₂→4H⁺+4e⁻ (1)

The generated electrons flow along an external circuit and to a cathode. The protons are delivered to the cathode through a polymer electrolyte membrane. As depicted in Reactions 2 and 3, oxygen molecules receive the electrons delivered to the cathode to be reduced to oxygen ions and then the protons react with the oxygen ions to produce water and generate electricity.

O₂+4e⁻→2O²⁻ (2)

2O²⁻+4H⁺→2H₂O (3)

Polymer electrolyte membranes for fuel cells are electrical insulators, but function as media that deliver protons (H⁺) from an anode to a cathode during operation of cells. Polymer electrolyte membranes also play a role in separating a fuel gas or liquid from an oxidant gas. Therefore, ion-exchange membranes for fuel cells must have excellent mechanical properties, high electrochemical stability and have low ohmic loss at a high current density.

At the early stage of the development of polymer electrolyte membranes for fuel cells in the 1960's, a great deal of research on hydrocarbon-based polymer membranes was conducted. Since perfluorinated sulfonic acid (Nafion) was developed by E.I. Du Pont de Nemours, Inc. in 1968, it has been predominantly used in fuel cells for installation and portable fuel cells.

Problems associated with fuel cells using Nafion type polymer electrolyte membranes include CO poisoning of electrode catalyst during low-temperature operations at 80° C. or lower and methanol crossover in direct methanol fuel cells (DMFCs), which deteriorates characteristics of the fuel cells and is a main cause of shortened lifespan. Considerable research is currently being conducted in an effort to solve these problems.

Further, fluorinated polymer electrolyte membranes, such as Nafion, can have other problems, such as thermal instability at temperatures of 90° C. or higher, difficulty in synthesis and expensive materials. In view of these and other problems associated with fluorinated polymer electrolyte membranes, sulfonated hydrocarbon-based polymer electrolytes are currently being developed to increase thermal stability of membranes and reduce costs.

However, since sulfonated hydrocarbon-based polymer electrolyte membranes are systems in which protonic conductivity can take place in the presence of moisture, a dehydration phenomenon occurs inside the membranes during high-temperature operations at 100° C. or higher, causing a rapid decrease in protonic conductivity.

Recent fuel cell systems require a polymer electrolyte membrane for a fuel cell that has high electricity generation efficiency and is suitable for high-temperature operations to utilize waste heat from household fuel cells.

The durability of fuel cells is very important for the commercialization of the fuel cells. That is, the characteristics of cells must not deteriorate despite long-term operation. Thus, there is a need to develop a polymer electrolyte membrane for a fuel cell with improved durability.

### SUMMARY OF THE INVENTION

The present invention provides a polymer electrolyte membrane for a fuel cell that can stably exhibit protonic conductivity due to improved resistance to radicals, which may be generated during operation of a fuel cell. The polymer electrolyte membrane is formed using a novel polymer structure that has stable protonic conductivity at high temperatures of 150° C. or higher, exhibits cell characteristics at high temperatures without humidification, and has good chemical resistance and excellent physical properties. The present invention further provides a membrane-electrode assembly using the electrolyte membrane; and a fuel cell comprising the assembly.

According to a first embodiment of the present invention, there is provided a polymer electrolyte membrane for a fuel cell, comprising:

a film comprising a polyimide copolymer containing phenylbenzimidazole moiety, the polyimide copolymer being represented by Formula 1:

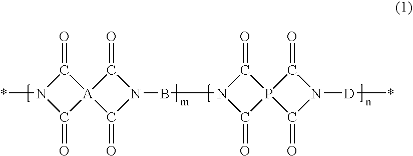

wherein B is a divalent organic group derived from diaminophenylbenzimidazole and is selected from groups represented by Formula 2:

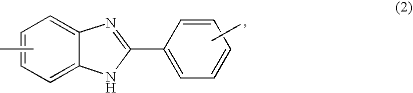

each A and P is a tetravalent organic group derived from an acid dianhydride and is independently selected from the following groups:

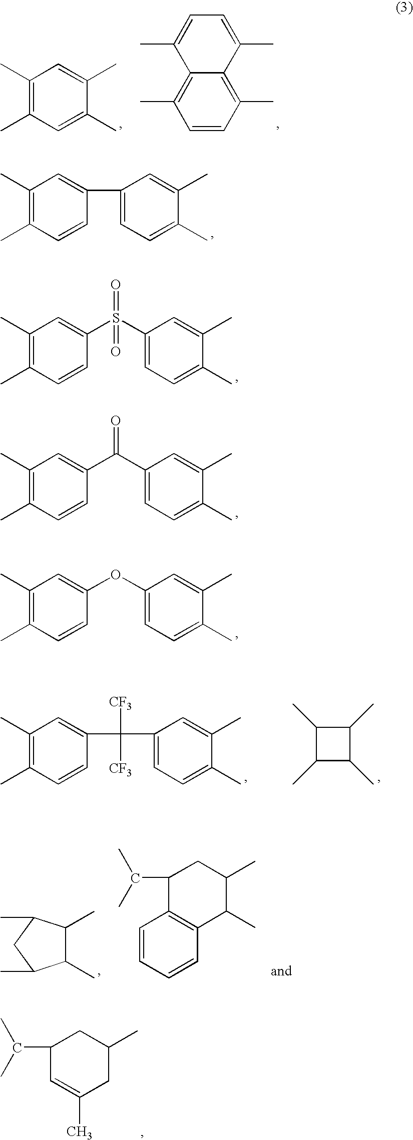

D is a divalent organic group derived from an aromatic diamine and is selected from the following groups:

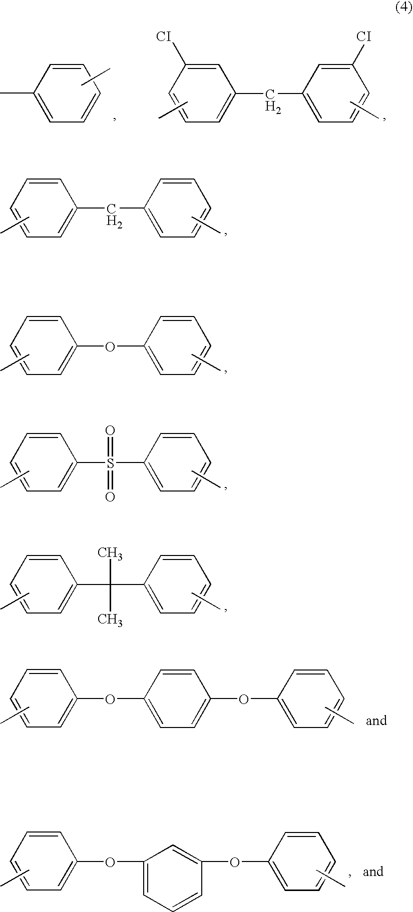

m and n satisfy the relationships: 0.5≦m/(m+n)≦1.0 and 0≦n/(m+n)≦0.5); and

an acid impregnated within the polyimide copolymer film.

The polyimide copolymer can have a number average molecular weight (Mn) of about 10,000 to about 500,000 g/mol.

In exemplary embodiments of the invention, in Formula 1, the molar ratio of A to P is about 1:1, the total mol % of A and P is 100%, and the total mol % of B and D is 100%.

If needed, the molar ratio of A to P may be varied to from about 1:0.9 to about 0.9:1 to adjust the molecular weight of the polymer to an optimal level. In this case, the total mol % of A and P or B and D may not be 100%.

In Formula 1, A and P may be the same dianhydride or different dianhydrides. If different dianhydrides are used as A and P in Formula 1, the molar ratio of B to D is different from the ratio of m to n and the molar ratio of A to P may be about 1:99, for example about 30:70.

In exemplary embodiments of the invention, B may be present in an amount of about 10 to about 100 mol % and D may be present in an amount of about 0 to about 90 mol %. In other exemplary embodiments of the invention, B may be present in an amount of about 50 to about 100 mol % and D may be present in an amount of about 0 to about 50 mol %. In yet other exemplary embodiments of the invention, B may be present in an amount of about 60 to about 95 mol % and D may be present in an amount of about 5 to about 40 mol %.

Representative examples of polyimide polymers that can be used to prepare the polyimide copolymer of Formula 1 include the following polymers:

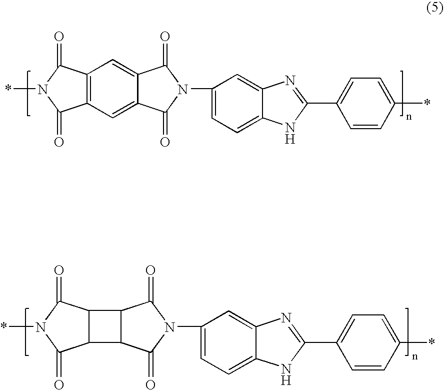

These polymers are provided to assist understanding of the present invention but are not intended to limit the structure of the polyimide polymer used in the present invention.

The polyimide polymer is used to form a polymer electrolyte membrane for a fuel cell, and explanation thereof will be provided below.

A polymer electrolyte membrane for a fuel cell can be formed using the polyimide polymer in accordance with the following procedure. First, a polymer film can be produced. Depending on polymerization and film production procedures, two methods may be employed to produce a polymer film using polyimide polymer.

According to a first method, a film having a thickness of about 10 to about 500 μm can be produced by preparing polyamic acid as a polyimide precursor, casting a solution of the polyamic acid to obtain a wet film, subjecting the wet film to dehydration by heating to 200° C. or higher to form an imide ring, and drying the heated film.

According to a second method, a film can be produced by performing chemical imidization using acetic dianhydride and pyridine in a solution state, solution polymerization using a basic catalyst (e.g., isoquinoline) in an acidic solvent (e.g., m-cresol) (solution polymerization using an acidic catalyst in a basic solvent is also possible) or imidization based on an azeotropic phenomenon using a solvent (e.g., toluene) in a basic solvent (e.g., N-methyl-2-pyrrolidone), precipitating the reaction product to obtain a solid polymer, dissolving the solid polymer in an organic solvent, casting the solution, and evaporating the solvent in a simple manner without performing imidization.

The final polyimide product polymerized in the second method is required to be dissolved in an organic solvent. Accordingly, the second method is typically used only when a particular monomer, such as an alicyclic acid dianhydride, is used.

To impart protonic conductivity (i.e. conductivity of hydrogen ions) to the polymer film produced by one of the methods, the polymer film is impregnated with an acid, such as phosphoric acid (H₃PO₄).

In the present invention, phosphoric acid having a concentration of about 85% is used to dope the polymer film. Other strong acids, such as sulfuric acid (H₂SO₄) and modified acids, such as ethylphosphoric acid, may also be used to impart protonic conductivity to the polymer film.

The polymer film is impregnated with the acid to complete the formation of a proton conductive polymer electrolyte membrane for a fuel cell.

According to a second embodiment of the present invention, there is provided a polymer electrolyte membrane for a fuel cell, comprising:

a polyimide copolymer film comprising a polyimide copolymer containing phenylbenzimidazole and a crosslinking agent having one or more crosslinkable reactive groups selected from epoxy groups, double bonds, triple bonds and amine groups, the polyimide copolymer being represented by Formula 6:

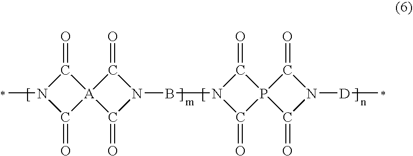

wherein B is a divalent organic group derived from diaminophenylbenzimidazole and is selected from groups represented by Formula 8:

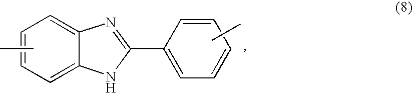

each A and P is a tetravalent organic group derived from an acid dianhydride and is independently selected from the following groups:

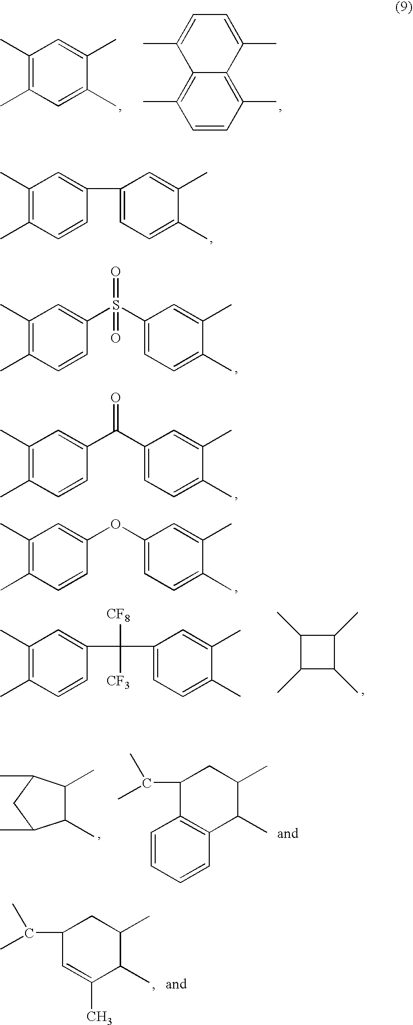

D is a divalent organic group derived from an aromatic diamine and is selected from the following groups:

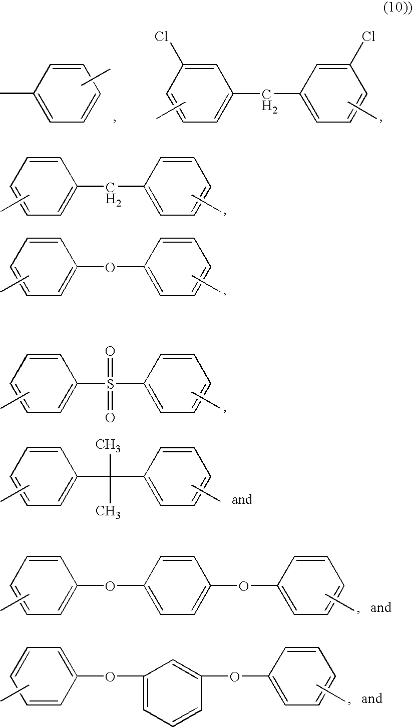

m and n satisfy the relationships: 0.5≦m/(m+n)≦1.0 and 0≦n/(m+n)≦0.5); and

the crosslinking agent being selected from the following compounds:

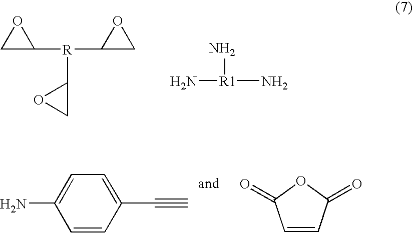

wherein R may be selected from alicyclic, aromatic and heteroaromatic moieties and the epoxy compound has two or more reactive functional groups, and R1 may be selected from aromatic and heteroaromatic moieties and the amine compound has three or more functional groups; and

an acid impregnated within the polyimide copolymer film.

As used herein, the term “functional group” includes groups such as but not limited to halogen, oxygen, hydroxyl, nitro, cyano, amino, and the like.

As used herein, the term “alicyclic moieties” can refer to substituted or unsubstituted C₅-C₃₀ cycloalkyl groups, which can optionally include one to three heteroatoms selected from N, O, P and S atoms in the ring. The alicyclic moieties can include one or more alicyclic rings in which the rings may be attached together in a pendent manner or may be fused. At least one hydrogen atom of the alicyclic moiety may be optionally substituted with a functional group as defined herein.

As used herein, the term “aromatic moieties” can refer to a substituted or unsubstituted C₆-C₃₀ cyclic aromatic system including one or more aromatic rings in which the rings may be attached together in a pendent manner or may be fused. At least one hydrogen atom of the aromatic moiety may be optionally substituted with a functional group as defined herein.

As used herein, the term “heteroaromatic moieties” can refer to a substituted or unsubstituted C₆-C₃₀ cyclic aromatic system including one to three heteroatoms selected from N, O, P and S atoms in the ring. The rings may be attached together in a pendant manner or may be fused. At least one hydrogen atom of the aromatic moiety may be optionally substituted with a functional group as defined herein.

The polymer electrolyte membrane according to the second embodiment of the present invention has good chemical resistance and improved physical properties when compared to those of the polymer electrolyte membrane according to the first embodiment of the present invention.

The number of functional groups included in the crosslinking agent having epoxy reactive groups is from 2 to 4. The content of this crosslinking agent in the polyimide composition is from about 1 to about 40 wt %, based on the solids content of the polymer.

The number of functional groups included in the crosslinking agent having amine reactive groups is 3 or 4. The content of this crosslinking agent in the polyimide composition is from about 1 to about 40 wt %, based on the solid content of the polymer.

The ethynylaniline is introduced into the end monomers of the polymer during polymerization and is used in an amount of about 2 to about 20 mol %.

The maleic anhydride is introduced into the end monomers of the polymer during polymerization and is used in an amount of about 2 to about 20 mol %.

The polyimide represented by Formula 6 is prepared and is processed into a film in the same manner as in the previous first embodiment. In the second embodiment, the chemical and physical properties of the polyimide are improved by the addition of a reactive crosslinking agent to the polyimide. A representative example of the polyimide and representative examples of the crosslinking agent are shown below:

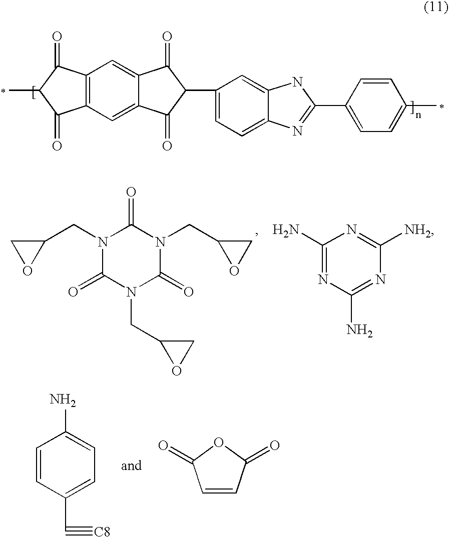

The polyimide and crosslinking agents are provided to assist understanding of the present invention but are not intended to limit the structure of the polyimide and crosslinking agents.

The polyimide and the crosslinking agent are used to form a polymer electrolyte membrane for a fuel cell, and explanation thereof will be provided below.

A polymer electrolyte membrane for a fuel cell can be formed using the polyimide polymer in accordance with the following procedure. First, a polymer film can be produced. Any widely known method may be employed to produce a polymer film using polyimide polymer. The methods described in the first embodiment may be employed in the second embodiment.

Methods for adding the crosslinking agent are largely divided into the following two methods, based on the kind of the crosslinking agent used.

According to a first method, the epoxy or triamine crosslinking agent can be added in the form of an additive without participation in the preparation of the polymer after completion of the polymerization. At this time, a quantitative amount of the epoxy or triamine crosslinking agent can be added to the reaction solution. The amount of the epoxy or triamine crosslinking agent added can be between about 1% and about 40%, for example between about 3% and about 30%, and as another example between about 5% and about 20%, based on the weight of the final polymer product.

According to a second method, the amine-terminated or anhydride-terminated crosslinking agent can be added during preparation of the polymer. When an amine-terminated crosslinking agent (e.g., ethynylaniline) is added, an acid dianhydride can be added in an amount of about 100 mol % and a diamine can be added in an amount of about 90 mol % to about 99 mol % to prepare the polyimide. At this time, the amine-terminated crosslinking agent can be added in an amount of about 2 mol % to about 20 mol %. When an anhydride-terminated crosslinking agent (e.g., maleic anhydride) is added, a diamine can be added in an amount of about 100 mol % and an acid dianhydride can be added in an amount of about 90 mol % to about 99 mol %, which is contrary to the addition of the amine-terminated crosslinking agent. At this time, the anhydride-terminated crosslinking agent is added in an amount of about 2 mol % to about 20 mol %.

The polyimide solution containing the crosslinking agent can be coated on a glass plate by casting, and heated stepwise to about 300° C. or higher to obtain a crosslinked polyimide film.

To impart protonic conductivity (i.e. conductivity of hydrogen ions) to the polymer film produced by one of the methods, the polymer film is impregnated with an acid, such as phosphoric acid (H₃PO₄).

In the present invention, phosphoric acid having a concentration of about 85% can be used to dope the polymer film (i.e. the polyimide film containing the crosslinking agent). Other strong acids, such as sulfuric acid (H₂SO₄) and modified acids, such as ethylphosphoric acid, may be also used to impart protonic conductivity to the polymer film.

The polymer film is impregnated with the acid to complete the formation of a proton conductive polymer electrolyte membrane for a fuel cell.

The polymer electrolyte membranes for fuel cells according to the embodiments of the present invention exhibit a high rate of impregnation with phosphoric acid and a high ionic conductivity even at high temperatures of 150° C. or higher without humidification. In addition, the polymer electrolyte membranes provide satisfactory characteristics and exhibit good chemical resistance and improved physical properties. Therefore, fuel cells employing the polymer electrolyte membranes provide excellent characteristics, such as high stability, even during long-term operation.

### BRIEF DESCRIPTION OF THE DRAWINGS

The above features and other advantages of the present invention will be more clearly understood from the following detailed description taken in conjunction with the accompanying drawings, in which:

FIG. 1 is a cross-sectional view schematically showing a membrane-electrode assembly (MEA) produced using a polymer electrolyte membrane of the present invention;

FIG. 2 is an exploded perspective view schematically showing a fuel cell comprising a membrane-electrode assembly of the present invention;

FIG. 3 is a graph showing I-V characteristics of a fuel cell fabricated using a polymer electrolyte membrane formed in Example 3 of the present invention, as evaluated at 150° C. without humidification;

FIG. 4 is a graph showing I-V characteristics of a fuel cell fabricated using a polymer electrolyte membrane formed in Example 9 of the present invention, as evaluated at 150° C. without humidification; and

FIG. 5 is a graph showing the results for the long-term operation stability of a test fuel cell fabricated using a polymer electrolyte membrane formed in Example 9 of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

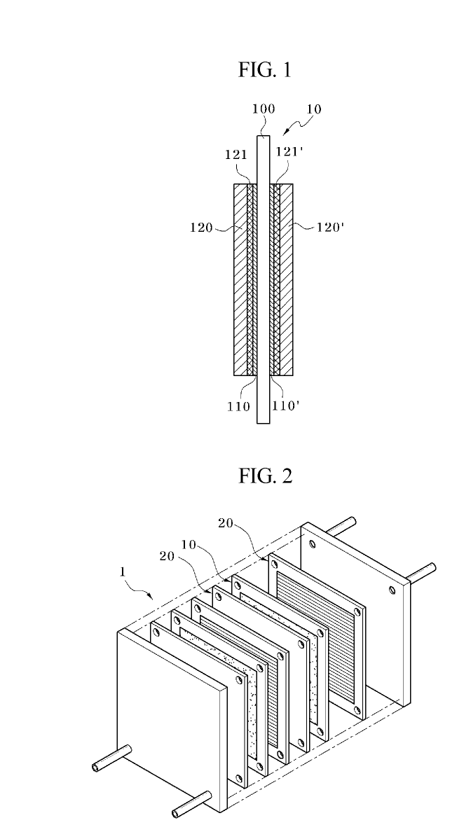

FIG. 1 is a cross-sectional view schematically showing a membrane-electrode assembly (MEA) produced using a polymer electrolyte membrane of the present invention.

Referring to FIG. 1, a membrane-electrode assembly 10 of the present invention comprises a polymer electrolyte membrane 100, catalyst layers 110 and 110′ coated on both surfaces of the polymer electrolyte membrane 100 by deposition, and gas diffusion layers 120 and 120′ disposed on the outer surfaces of the respective catalyst layers.

The catalyst layers 110 and 110′ can contain at least one catalyst selected from the group consisting of platinum, ruthenium, osmium, platinum-ruthenium alloys, platinum-osmium alloys, platinum-palladium alloys, and alloys of platinum with at least one transition metal selected from the group consisting of Ga, Ti, V, Cr, Mn, Fe, Co, Ni, Cu and Zn. A mixture of the catalyst and carbon black can be used to form the catalyst layers.

The gas diffusion layers (GDLs) 120 and 120′ are disposed on the outer surfaces of the respective catalyst layers 110 and 110′.

The gas diffusion layers 120 and 120′ serve to supply sufficient hydrogen and oxygen gases from the outside to the catalyst layers to assist in the formation of three-phase interfaces of the catalyst layers, the electrolyte membrane and the gas. The gas diffusion layers can be formed of carbon paper or carbon cloth.

The membrane-electrode assembly 10 of the present invention may further comprise microporous layers (MPLs) 121 and 121′ disposed between the catalyst layer 110 and the gas diffusion layer 120 and between the catalyst layer 110′ and the gas diffusion layer 120′, respectively. The microporous layers 121 and 121′ are formed to assist in the diffusion of hydrogen and oxygen gases.

FIG. 2 is an exploded perspective view schematically showing a fuel cell comprising the membrane-electrode assembly.

Referring to FIG. 2, the fuel cell 1 of the present invention comprises the membrane-electrode assembly 10 and bipolar plates 20 arranged on both sides of the membrane-electrode assembly.

Hereinafter, the constitutions and effects of the present invention will be explained in more detail with reference to the following specific examples and comparative examples. However, these examples serve to provide further appreciation of the invention but are not meant in any way to restrict the scope of the invention.

### EXAMPLES

### 1. Examples Illustrating Effects of Polymer Electrolyte Membranes According to the First Embodiment of the Present Invention

### Example 1

One mole of 6,4′-diamino-2-phenylbenzimidazole (Formula 12) as a diamine is dissolved in N-methyl-2-pyrrolidone (NMP, Junsei Chemical) in a four-neck flask equipped with an agitator, a thermostat, a nitrogen injection system and a condenser while passing nitrogen through the flask.

To the solution is added 1 mole of pyromellitic dianhydride (PMDA, Cat. No. B0040, Tokyo Chemical Industry). The mixture is vigorously stirred. The solids content of the mixture is 15 wt %. The mixture is allowed to react for 24 hours while maintaining the temperature below 25° C. to prepare a polyamic acid solution (PAA-1).

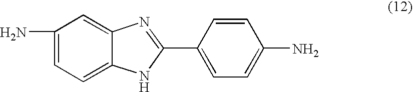

### Example 2

A polyamic acid solution (PAA-2) is prepared in the same manner as in Example 1, except that 0.5 moles of 4,4′-diaminodiphenylether as a diamine (Cat. No. 00088, Tokyo Chemical Industry) and 0.5 moles of 6,4′-diamino-2-phenylbenzimidazole are used.

### Example 3

A polyamic acid solution (PAA-3) is prepared in the same manner as in Example 1, except that 0.3 moles of 4,4-diaminodiphenylether, 0.7 moles of 6,4′-diamino-2-phenylbenzimidazole and 1 mole of pyromellitic dianhydride (PMDA) are used.

### Example 4

A polyamic acid solution (PAA-4) is prepared in the same manner as in Example 1, except that 0.3 moles of 4,4′-diaminodiphenylether, 0.7 moles of 6,4′-diamino-2-phenylbenzimidazole and 1 mole of 1,4,5,8-naphthalene tetracarboxylic dianhydride (Cat. No. NO369, Tokyo Chemical Industry) are used.

### Example 5

A polyamic acid solution (PAA-5) is prepared in the same manner as in Example 1, except that 1 mole of 6,4′-diamino-2-phenylbenzimidazole and 1 mole of 1,4,5,8-naphthalene tetracarboxylic dianhydride are used.

### Example 6

A polyamic acid solution (PAA-6) is prepared in the same manner as in Example 1, except that 0.3 moles of 4,4′-diaminodiphenylether, 0.7 moles of 6,4′-diamino-2-phenylbenzimidazole and 1 mole of 3,3′,4,4′-benzophenonetetracarboxylic dianhydride (Cat. No. NO369, Tokyo Chemical Industry) are used.

### Example 7

A polyamic acid solution (PAA-7) is prepared in the same manner as in Example 1, except that 1 mole of 6,4′-diamino-2-phenylbenzimidazole and 1 mole of 3,3′,4,4′-benzophenonetetracarboxylic dianhydride are used.

Polyimide polymer films are produced using the respective polyamic acid solutions prepared in Examples 1 to 7. The characteristics of the polyimide polymer films and the impregnation properties of the polyimide polymer films with phosphoric acid are evaluated. The results are shown in Table 1.

TABLE 1

| | | Thickness of | Thickness after | |
|---|---|---|---|---|
| | Film | dry film | impregnation | ^{a}Rate of |
| Polymer | formation | (μm) | (μm) | impregnation (%) |
| Example 1 | ◯ | 28 | 70 | 455 |
| Example 2 | ◯ | 31 | 49 | 300 |
| Example 3 | ◯ | 32 | 43 | 280 |
| Example 4 | ◯ | 35 | 61 | 260 |
| Example 5 | ◯ | 32 | 65 | 410 |
| Example 6 | ◯ | 36 | 48 | 240 |
| Example 7 | ◯ | 29 | 51 | 325 |

Note:
^{a}= (weight of a membrane after impregnation − weight of dry film) × 100

As can be seen from the data shown in Table 1, the polyimide polymer films have a high rate of impregnation with phosphoric acid.

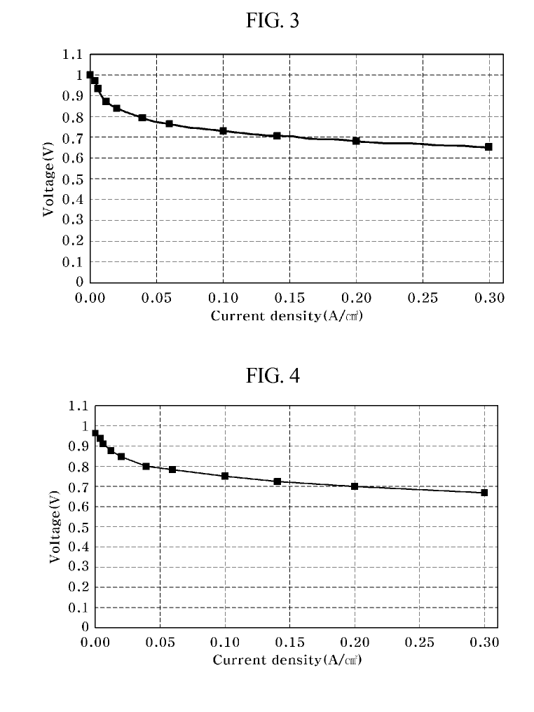

A fuel cell is fabricated using a polymer electrolyte membrane formed in Example 3. The I-V characteristics of the fuel cell are evaluated at 150° C. without humidification. The results are shown in FIG. 3.

The results of FIG. 3 demonstrate that the fuel cell, which is fabricated using a polymer electrolyte membrane formed in Example 3, shows voltage values as high as 600 mV in the current range of 0 to 0.3 A/cm².

### 2. Examples Illustrating Effects of Polymer Electrolyte Membranes According to the Second Embodiment of the Present Invention

### Example 8

Polyimide is prepared in the same manner as in Example 1, and then a solution of 15 wt % of socyanuric acid triglycidyl ester (Cat. No. 10428, Tokyo Chemical Industry) in N-methyl-2-pyrrolidone (NMP, Junsei Chemical) is added thereto. At this time, the socyanuric acid triglycidyl ester is used in an amount of 20 wt %, based on the solids content of the polymer. The mixture is vigorously stirred using a mechanical agitator for 6 hours to prepare a homogeneous polymer solution.

### Example 9

Polyimide is prepared in the same manner as in Example 1, and then a solution of 15 wt % of socyanuric acid triglycidyl ester (Cat. No. 10428, Tokyo Chemical Industry) in N-methyl-2-pyrrolidone (NMP, Junsei Chemical) is added thereto. At this time, the socyanuric acid triglycidyl ester is used in an amount of 5 wt %, based on the solids content of the polymer. The mixture is vigorously stirred using a mechanical agitator for 6 hours to prepare a homogeneous polymer solution.

### Example 10

Polyimide is prepared in the same manner as in Example 1, and then a solution of 15 wt % of a melamine monomer (Cat. No. T0337, Tokyo Chemical Industry) in N-methyl-2-pyrrolidone (NMP, Junsei Chemical) is added thereto. At this time, the socyanuric acid triglycidyl ester is used in an amount of 10 wt %, based on the solids content of the polymer. The mixture is vigorously stirred using a mechanical agitator for 6 hours to prepare a homogeneous polymer solution.

### Example 11

Polyimide is prepared in the same manner as in Example 1, and a polyamic acid solution is prepared in the same manner as in Example 1, except that 0.95 moles of 6,4′-diamino-2-phenylbenzimidazole and 0.1 moles of 4-ethylnylaniline (Cat. No. E0505, Tokyo Chemical Industry) are used.

### Example 12

Polyimide is prepared in the same manner as in Example 1, and a polyamic acid solution is prepared in the same manner as in Example 1, except that 0.95 moles of pyromellitic dianhydride (PMDA, Cat. No. B0040, Tokyo Chemical Industry) and 0.1 moles of maleic anhydride (Cat. No. M0005, Tokyo Chemical Industry) are used.

Crosslinked polyimide films are produced using the respective polyamic acid solutions prepared in Examples 8. The crosslinked polyimide films are tested for chemical resistance. The results are shown in Table 2.

TABLE 2

| | | Weight (g) of | Weight (g) of | Weight |
|---|---|---|---|---|
| | Film | film before | film after | retention |
| Polymer | formation | Fenton's test | Fenton's test | rate (%) |
| Example 8 | ◯ | 0.0534 | 0.0502 | 94 |
| Example 9 | ◯ | 0.0475 | 0.0437 | 92 |
| Example 10 | ◯ | 0.0544 | 0.0473 | 87 |
| Example 11 | ◯ | 0.0716 | 0.0558 | 78 |
| Example 12 | ◯ | 0.0561 | 0.0465 | 83 |
| Example 1 | ◯ | 0.0423 | Brittle | Not |
| | | | | measurable |

The chemical resistance test is conducted by Fenton's test. Specifically, 20 ppm FeSO₄ is dissolved in a hydrogen peroxide solution to prepare a solution for Fenton's test. Each of the polyimide films is added to the solution in a container. The solution in which the polyimide film is dipped is shaken using a shaker in a water bath at 80° C. for 6 hours. Thereafter, the film is taken out of the solution, washed with water, dried in a vacuum oven at 60° C. for 3 hours, and weighed.

As is evident from the results of Table 2, the film of Example 1 containing no crosslinking agent is very brittle and shows a great loss in weight after the Fenton's test. That is, it is impossible to measure the weight retention rate of the film.

In contrast, the films of Examples 8 to 12 containing a crosslinking agent show a relatively high weight retention rate even after the Fenton's test. Particularly, the weight retention rate of the film produced in Example 8 is very high (94%).

A fuel cell is fabricated using the polymer electrolyte membrane formed in Example 9. The I-V characteristics of the fuel cell are evaluated at 150° C. without humidification. The results are shown in FIG. 4.

The results of FIG. 4 demonstrate that the fuel cell, which is fabricated using the polymer electrolyte membrane formed in Example 9, shows a voltage value as high as 670 mV at a current density of 0.3 A/cm².

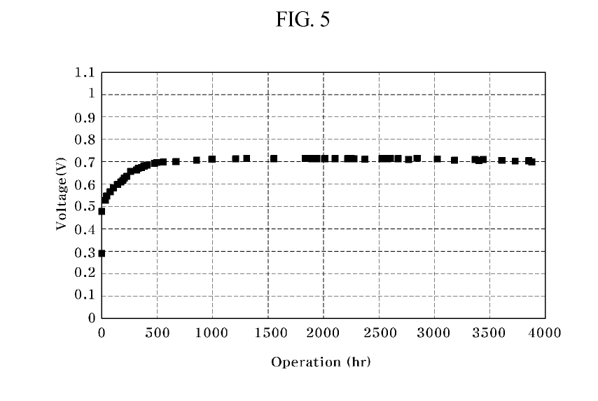

A test fuel cell is fabricated using the polymer electrolyte membrane formed in Example 9. The test fuel cell is evaluated for long-term operation stability. The results are shown in FIG. 5.

Although not shown in FIG. 5, a fuel cell fabricated using the film produced in Example 1 containing no crosslinking agent shows poor durability (<300 hours), whereas a fuel cell fabricated using the film produced in Example 1 containing a crosslinking agent shows markedly improved durability (≧3,500 hours) under long-term operation conditions at a current density of 0.2 A/cm².

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A polymer electrolyte membrane for a fuel cell, comprising:
a film comprising a polyimide copolymer represented by Formula 1: 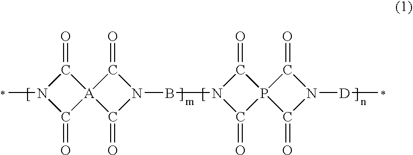
wherein each A and P is independently a tetravalent organic group derived from an acid dianhydride,
B is selected from groups represented by Formula 2: 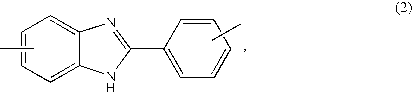
D is selected from divalent organic groups derived from aromatic diamines, and
m and n satisfy the relationships: 0.5≦m/(m+n)≦1.0 and 0≦n/(m+n)≦0.5); and
an acid impregnated within the polyimide copolymer film.

2. The polymer electrolyte membrane according to claim 1, wherein each A and P is independently selected from

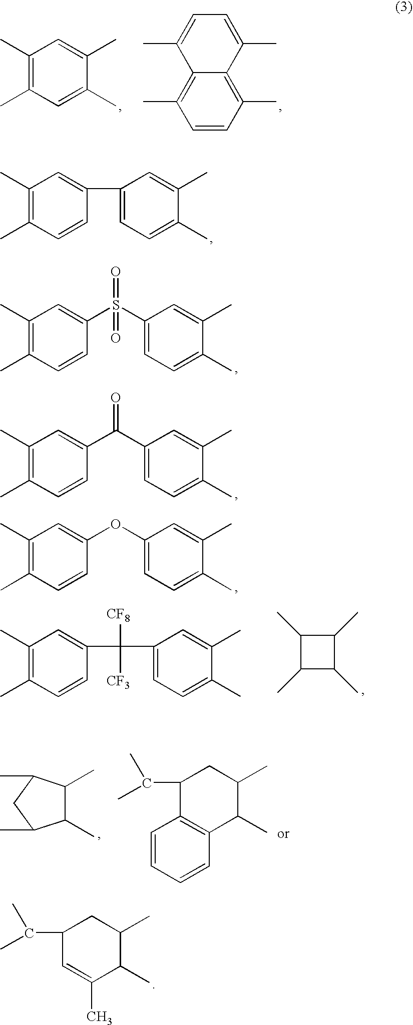

3. The polymer electrolyte membrane according to claim 1, wherein A and P are the same dianhydride and have a molar ratio of about 1:1.

4. The polymer electrolyte membrane according to claim 1, wherein A and P are different dianhydrides and have a molar ratio of about 1:1.

5. The polymer electrolyte membrane according to claim 1, wherein D is selected from

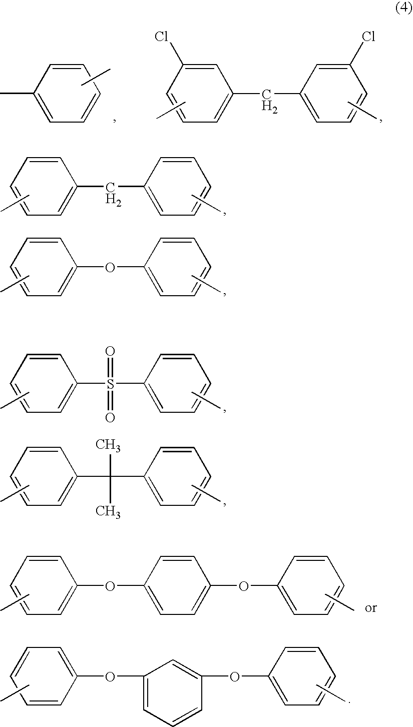

6. A polymer electrolyte membrane for a fuel cell, comprising:
a polymer film comprising a polyimide copolymer represented by Formula 6: 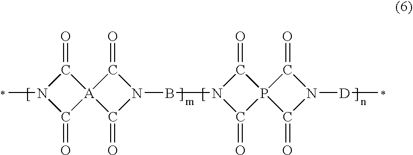
wherein each A and P is a tetravalent organic group derived from an acid dianhydrides independently selected from 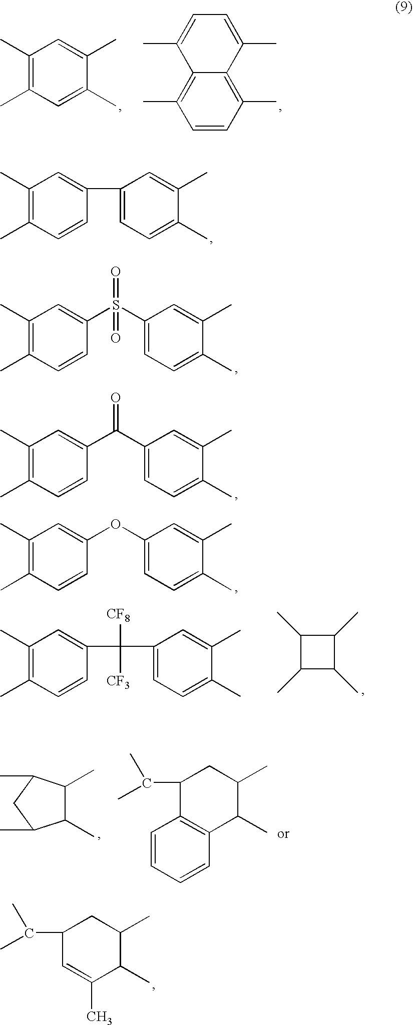
B is selected from groups represented by Formula 8: 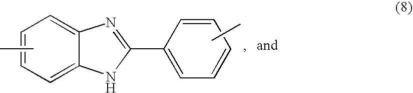
D is a divalent organic group derived from an aromatic diamine selected from 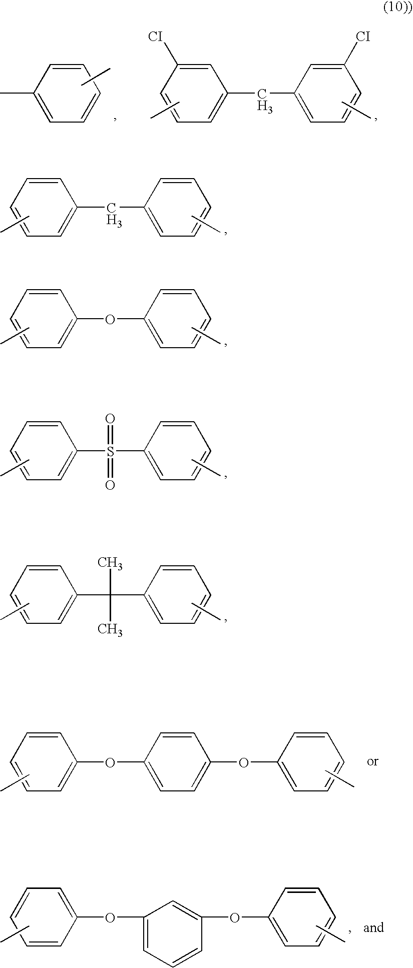
m and n satisfy the relationships: 0.5≦m/(m+n)≦1.0 and 0≦n/(m+n)≦0.5);
a crosslinking agent selected from the group consisting of: 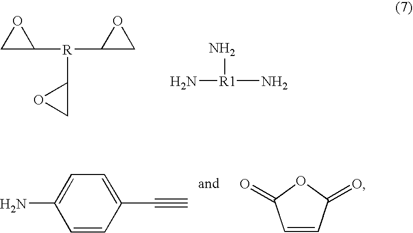
and combinations thereof (7)
wherein R is selected from alicyclic, aromatic and heteroaromatic moieties and the epoxy compound has two or more reactive functional groups, and R1 is selected from aromatic and heteroaromatic moieties and the amine compound has three or more functional groups; and
an acid impregnated within the polyimide copolymer film.

7. The polymer electrolyte membrane according to claim 6, wherein the crosslinking agent having epoxy reactive groups has two to four functional groups and is present in an amount of about 1 to about 40 wt %, based on the solids content of the polymer.

8. The polymer electrolyte membrane according to claim 6, wherein the crosslinking agent having amine reactive groups has three or four functional groups and is present in an amount of about 1 to about 40 wt %, based on the solid content of the polymer.

9. The polymer electrolyte membrane according to claim 6, wherein the ethynylaniline is introduced into the end monomers of the polymer during polymerization and is used in an amount of about 2 to about 20 mol %.

10. The polymer electrolyte membrane according to claim 6, wherein the maleic anhydride is introduced into the end monomers of the polymer during polymerization and is used in an amount of about 2 to about 20 mol %.

11. A membrane-electrode assembly comprising:
a polymer electrolyte membrane according to claim 1,
catalyst layers coated on both surfaces of the polymer electrolyte membrane by deposition, and
gas diffusion layers disposed on the outer surfaces of the respective catalyst layers.

12. A membrane-electrode assembly comprising:
a polymer electrolyte membrane according to claim 6,
catalyst layers coated on both surfaces of the polymer electrolyte membrane by deposition, and
gas diffusion layers disposed on the outer surfaces of the respective catalyst layers.

13. A fuel cell comprising:
a membrane-electrode assembly according to claim 11, and
bipolar plates arranged on both sides of the membrane-electrode assembly.

14. A fuel cell comprising:
a membrane-electrode assembly according to claim 12, and
bipolar plates arranged on both sides of the membrane-electrode assembly.
